(19) United States
(12) Patent Application Publication
(10) Pub. No.: US 2019/0333040 A1
(43) Pub. Date: Oct. 31, 2019

(54) METHOD OF ACCESSING PAYMENT TERMINAL, TERMINAL AND NON-VOLATILE READABLE STORAGE MEDIUM

(71) Applicant: PAX COMPUTER TECHNOLOGY (SHENZHEN) CO., LTD, Shenzhen, Guangdong (CN)

(72) Inventors: Jianqiang Li, Shenzhen, Guangdong (CN); Mingfei Wei, Shenzhen, Guangdong (CN)

(21) Appl. No.: 16/470,735

(22) PCT Filed: Aug. 30, 2017
(86) PCT No.: PCT/CN2017/099738

§ 371 Date: Jun. 18, 2019

(30) Foreign Application Priority Data
Dec. 28, 2016 (CN) 201611238404.X

(51) Int. Cl. G06Q 20/20; H04L 29/06; H04L 29/08

(52) U.S. Cl. CPC G06Q 20/206; H04L 67/34; H04L 63/101

(57) ABSTRACT

A method for accessing payment terminal, including: acquiring page access information through a browser; loading a corresponding page according to the page access information and generating an access control object; receiving an operation selected on the page; calling the access control object according to the operation; and accessing a connected payment terminal through the access control object, and controlling the payment terminal to perform the operation.

### CROSS-REFERENCE OF RELATED APPLICATION

This application claims priority to Chinese Patent Application No. 201611238404.X, filed with China National Intellectual Property Administration on Dec. 28, 2016, and titled “method and device for accessing payment terminal”, the content of which is incorporated herein by reference in entirety.

### TECHNICAL FIELD

The present disclosure relates to the field of computer technology, and more particularly to a method for accessing payment terminal, a terminal for accessing payment terminal and a non-volatile readable storage medium.

### BACKGROUND

With the rapid development of the internet technology, more and more payment terminals (POS, Point Of Sale) which are convenient to use are available in the market, these payment terminals may be connected with an intelligent device such as a mobile phone and a tablet computer and so on, and data transmission is perform over the internet. A payment terminal may complete operations such as card reading, PIN (Personal Identification Number) input, data encryption and decryption, displaying of prompt information and so on, so that the application of payment function is realized.

In the traditional mode, in the event that the payment function of the payment terminal needs to be used, except for connecting the payment terminal with the intelligent device, it also needs to install a corresponding local application in the intelligent device, then, the payment terminal is accessed through the local application and is controlled to perform the corresponding operation, the operation is complicated.

### SUMMARY

According to the various embodiments of the present disclosure, a method for accessing payment terminal, a terminal for accessing payment terminal and a non-volatile readable storage medium is provided.

A method of accessing a payment terminal, including:
acquiring page access information through a browser;
loading a corresponding page according to the page access information and generating an access control object;
receiving an operation selected on the page;
calling the access control object according to the operation; and
accessing a connected payment terminal through the access control object and controlling the payment terminal to perform the operation.

A terminal, including a memory and a processor, the memory being configured to store computer-executable instruction, when the computer-executable instruction is executed by the processor, the processor is caused to perform following steps of:
acquiring page access information through a browser;
loading a corresponding page according to the page access information and generating an access control object;
receiving an operation selected on the page;
calling the access control object according to the operation; and
accessing a connected payment terminal through the access control object and controlling the payment terminal to perform the operation.

A non-volatile readable storage medium storing computer-executable instruction, when the computer-executable instruction is executed by one or a plurality of processors, the one or plurality of processors are caused to perform the following steps of:
acquiring page access information through a browser;
loading a corresponding page according to the page access information and generating an access control object;
receiving an operation selected on the page;
calling the access control object according to the operation; and
accessing a connected payment terminal through the access control object and controlling the payment terminal to perform the operation.

The details of one or more embodiments in the present disclosure are proposed in the accompanying figures and descriptions below. Other technical features, objectives and advantages in the present disclosure will become obvious from the description, the accompanying figures and the claims.

### BRIEF DESCRIPTION OF THE DRAWINGS

In order to explain the embodiments of the present disclosure more clearly, a brief introduction regarding the accompanying drawings that need to be used for describing the embodiments of the present disclosure or the related art is given below; it is obvious that the accompanying drawings described as follows are only some embodiments of the present disclosure, for the person of ordinary skill in the art, other drawings may also be acquired according to the current drawings on the premise of without paying creative labor.

FIG. 1 depicts an application scenario of a method for accessing payment terminal in one embodiment;

FIG. 2 depicts a block diagram of an intelligent terminal in one embodiment;

FIG. 3 depicts a flow diagram of the method for accessing payment terminal in one embodiment;

FIG. 4 depicts a flow diagram of loading a page and generating an access control object in one embodiment;

FIG. 5 depicts a flow diagram of creating a service component object in one embodiment;

FIG. 6 depicts a flow diagram of calling the service component object according to the access control object in order that the service component object communicates with a connected payment terminal and controls the payment terminal to perform an operation in one embodiment;

FIG. 7 depicts a system architecture diagram of the method for accessing the payment terminal in one embodiment;

FIG. 8 depicts a block diagram of a device for accessing payment terminal in one embodiment;

FIG. 9 depicts a block diagram of a generation module in one embodiment;

FIG. 10 depicts a block diagram of a device for accessing payment terminal in another embodiment;

FIG. 11 depicts a block diagram of a creating module in one embodiment; and

FIG. 12 depicts a block diagram of an accessing module in one embodiment.

### DESCRIPTION OF THE EMBODIMENTS

In order to make the purpose, the technical solution and the advantages of the present disclosure be clearer and more understandable, the present disclosure will be further described in detail below with reference to accompanying figures and embodiments. It should be understood that the specific embodiments described herein are merely intended to explain but not to limit the present disclosure.

It should be understood that, the terms used in the present disclosure such as “the first”, “the second” and the like may be used for describing various elements in the present disclosure; however, these elements are not limited by the terms. These terms are only used to distinguish one element from another element. For example, at the premise of without departing from the protection scope of the present disclosure, the first client may be referred to as the second client, and similarly, the second client may be referred to as the first client. Both the first client and the second client are clients, however, the first client and the second client are not the same client.

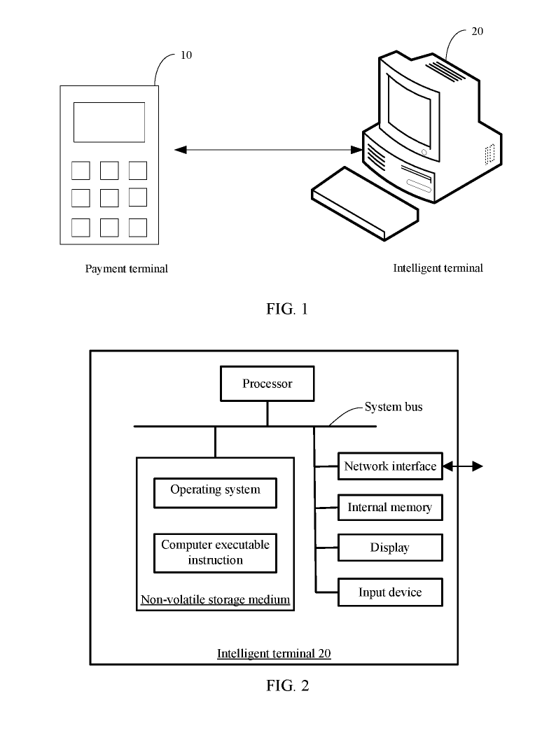

FIG. 1 depicts an application scenario diagram of a method for accessing a payment terminal 10 in one embodiment. In this application scenario, the payment terminal 10 may be connected with an intelligent terminal 20 through an USB (Universal Serial Bus) interface. A user accesses a corresponding page through a browser on the intelligent terminal 20, the intelligent terminal 20 acquires page access information through the browser, loads a corresponding page according to the page access information, and generates an access control object. The intelligent terminal 20 receives an operation selected by the user on the page, calls the access control object according to the operation, accesses a connected payment terminal 10 through the access control object, and control the payment terminal 10 to perform the operation selected by the user on the page.

FIG. 2 depicts a block diagram of the intelligent terminal 20 in one embodiment. As shown in FIG. 2, the intelligent terminal 20 includes a processor connected through a system bus, a non-volatile storage medium, an internal memory, a network interface, a display screen and an input device. The non-volatile storage medium of the intelligent terminal 20 stores an operating system and a computer-executable instruction, when the computer-executable instruction is executed by the processor, the method for accessing the payment terminal 10 provided in the embodiments of the present disclosure is realized. The processor is configured to provide calculation and control capability, and support the operation of the whole intelligent terminal 20. The internal memory in the intelligent terminal 20 is configured to provide an environment for the operation of the computer-executable instruction in the non-volatile storage medium. The network interface is configured to perform network communication with a server, such as sending an access request to the server, and receiving a processing result as returned by the server, and the like. The display screen of the intelligent terminal may be a LCD (Liquid Crystal Display) screen or an electronic ink display screen, or the like; the input device may be a touch layer covered on the display screen, the input device may also be a key, a trackball or a touch panel which are arranged on the outer shell of the intelligent terminal, the input device may also be a peripheral keyboard, a touch control panel or a mouse or the like. The intelligent terminal 20 may be a mobile phone, a tablet computer or a personal digital assistant or a wearable device, or the like. The person of ordinary skilled in the art may be aware of that the structure shown in FIG. 2 is merely a block diagram of some structures associated with the technical solution of the present disclosure, but should not be constituted as the limitation to the intelligent terminal 20 on which the technical solution of the present disclosure is applied. Particularly, the intelligent terminal 20 may include more or less components than the components shown in the figures, or combine some components or have different component arrangements.

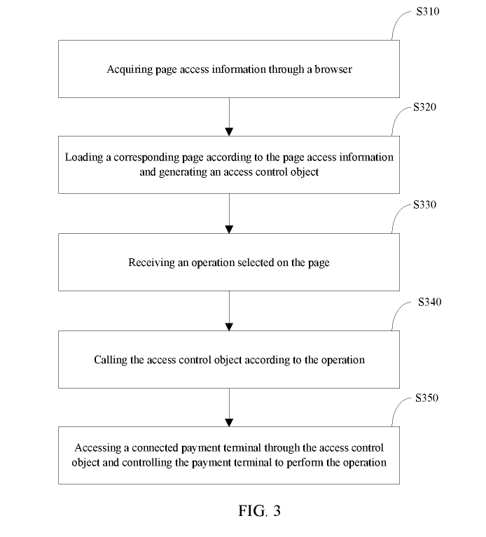

As shown in FIG. 3, in one embodiment, a method for accessing a payment terminal 10 is provided, and this method may be applied to the intelligent terminal as shown in FIG. 2 and include the following steps:

Step 310, acquiring page access information through a browser.

Particularly, a user may access the corresponding payment page through the browser on the intelligent terminal according to an actual requirement, the payment page may include a payment page of each of the various large banks, a third-party payment page such as PayPal, and the like. When the user accesses the corresponding page through the browser, the intelligent terminal may acquire page access information through the browser, the page access information may include information including URL (Uniform Resource Locator) and access time.

Step 320, loading a corresponding page according to the page access information and generating an access control object.

Particularly, the intelligent terminal may send a HTTP (Hypertext Transfer Protocol) request or a HTTPS (Hypertext Transfer Protocol over Secure Socket Layer) request to a corresponding website server according to the page URL in the page access information and acquire a resource related to the page, and load the page. An access control may be embedded in the HTML (Hypertext Markup Language) previously; when the intelligent terminal loads the page, the access control registered on the intelligent terminal may be called through JS (JavaScript) in the page, and an access control object is generated according to the access control registered on the intelligent terminal.

The access control may be an ActiveX control, and the ActiveX control may also be called as an OLE (Object Linking and Embedding) control or an OCX (Object Linking and Embedding Control Extension) control, the ActiveX control is very small program used for the internet, the ActiveX control is some program components or objects and may be embedded into web pages or other applications.

Step 330, receiving an operation selected on the page.

Particularly, the user may select the required operation on the page of the browser, where the operation may include payment, card reading, password input, balance checking, checking of the state of the payment terminal 10, and the like.

Step 340, calling the access control object according to the operation.

Particularly, the intelligent terminal receives the operation selected by the user on the page, and communicates with a connected payment terminal 10 through an interface corresponding to the selected operation provided by the JS in the page by calling the access control object; where, the payment terminal may include a traditional POS (Point of Sale) machine and a simple POS machine, a wireless POS machine and the like, and the payment terminal 10 may be connected with the intelligent terminal through an interface such as the USB and the like, or use GSM (Global System for Mobile Communication) to connect to and communicate with the intelligent terminal.

Step 350, accessing the connected payment terminal 10 according to the access control object, and controlling the payment terminal 10 to perform the operation.

Particularly, the page accessed by the user in the intelligent terminal may access the payment terminal 10 connected with the intelligent terminal by calling the access control object, the access control object generates a corresponding operation instruction according to the operation selected by the user on the page and transmits the operation instruction to the payment terminal 10 through such as a serial port or a GSM communication module, the payment terminal 10 may perform corresponding operation according to the operation instruction.

In the aforesaid method for accessing payment terminal 10, the page access information is acquired through the browser, the corresponding page is loaded according to the page access information and the access control object is generated, the operation selected on the page is generated, and the access control object is called according to the operation, the connected payment terminal 10 is accessed through the access control object, and the payment terminal 10 is controlled to perform the corresponding operation, the page may access and control the payment terminal 10 by calling the access control object, there is no need for the user to install a local application in the intelligent equipment in advance; the user may only need to open the browser to access the corresponding web page so as to use the connected payment terminal, and the operation is simple, rapid and convenient.

Moreover, with regard to different issuing parties of the payment terminal 10, there is no need for the issuing parties to develop an independent application for the user to use, the issuing parties only need to develop the corresponding web pages so that the access control may be called through the web page, huge development cost is saved.

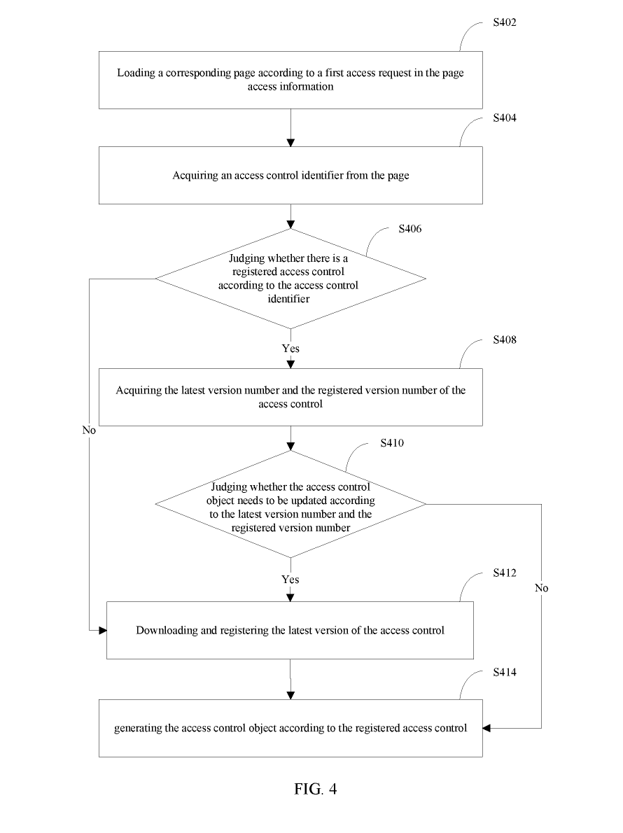

As shown in FIG. 4, in one embodiment, loading the corresponding page according to the page access information and generating an access control object in step 320 includes the following steps:

Step 402, loading a corresponding page according to the page access information.

Particularly, the corresponding website server may be accessed by the intelligent terminal according to the page URL in the page access information, and the resource related to the page is acquired, and the page is loaded.

Step 404, acquiring an access control identifier from the page.

Particularly, the embedded access control identifier may be acquired by the intelligent terminal from the HTML of the page, where the access control identifier may be composed of one or more among numbers, letters, symbols and the like.

Step 406, judging whether there is a registered access control according to the access control identifier, and performing step 408 if there is the registered access control, or performing step 412 if there is no registered access control.

Particularly, the intelligent terminal may look up in the registry of the operating system according to the access control identifier, and determines whether there is the registered access control, if the registered access control is contained in the registry, it indicates that there is the registered access control; if the access control identifier isn't contained in the registry, it indicates that there is no registered access control.

Step 408, acquiring the latest version number and the registered version number of the access control.

Step 410, judging whether the access control needs to be updated according to the latest version number and the registered version number, and performing step 412 if the access control needs to be updated, or performing step 414 if the access control need not to be updated.

Particularly, the latest version number of the access control may be acquired from the HTML of the page if the access control is registered in the operating system of the intelligent terminal, and the registration version number of the access control is acquired from the registry. Whether the access control needs to be updated may be judged according to the newest version number and the registration version number of the access control, if the latest version number is identical to the registration version number, the access control need not to be updated, if the latest version number is different from the registration version number, the access control needs to be updated.

Step 412, downloading and registering the latest version of the access control.

Particularly, the latest version of the access control may be downloaded by the intelligent terminal from the website server or the server corresponding to the payment terminal 10, if the access control is not registered in the operating system of the intelligent terminal, or the registered access control is not the latest version and needs to be updated. After downloading of the latest version of access control is completed, the access control may be registered according to the setup.inf file in the downloaded access control, and the access control identifier and the corresponding version number are written into the registry. The access control may be normally used after the access control is registered.

The developer of the payment terminal 10 may issue various versions of access controls in a cab package mode, the access controls are issued through the cab package, when the user accesses the corresponding page through the browser, the access control may be automatically updated and installed by the page, and updating and installation of the access control is convenient and rapid. In other embodiments, the access control may be issued in the manner of such as exe installation package.

Step 414, generating the access control object according to the registered access control.

Particularly, the registered access control may be called by the intelligent terminal through the JS (JavaScript) in the page, and the access control object is generated by the intelligent terminal according to the registered access control, an interface called by JS is provided in the access control object, the interface in the access control object is called such that the corresponding service component may be called to communicate with the payment terminal 10, and the payment terminal 10 is controlled to perform the corresponding operation.

In one embodiment, a corresponding page is loaded according to page access information and an access control object is generated, the page may call the access control object to access and control the payment terminal 10, there is no need for the user to install a local application in the intelligent device in advance, the user may only need to open the browser to access the corresponding web page so as to use the payment terminal 10, the operation is simple, rapid and convenient.

In one embodiment, after loading a corresponding page according to the page access information and generating the access control object in step 320, the method further includes: creating a service component object through the access control object.

Particularly, the service component is a COM component, and usually exists in the form of a DLL (Dynamic Link Library) file, the service component are actually some small binary executable programs, and may provide services for applications, operating system and other component. When the access control is downloaded by the intelligent terminal, the service component which may be used for communicating with the payment terminal 10 is downloaded simultaneously, and the service component may be registered in the manner of such as regsvr32 command and so on. After the access control object is generated by the JS in the page according to the access control registered in the operating system, the interface corresponding to the access control object may be called in order that the access control object creates the service component object according to the registered service component, the service component object provides a series of interfaces for controlling the payment terminal 10, the access control object may call the interfaces provided by the service component object to access the payment terminal 10, and control the payment terminal 10 to perform the corresponding operation.

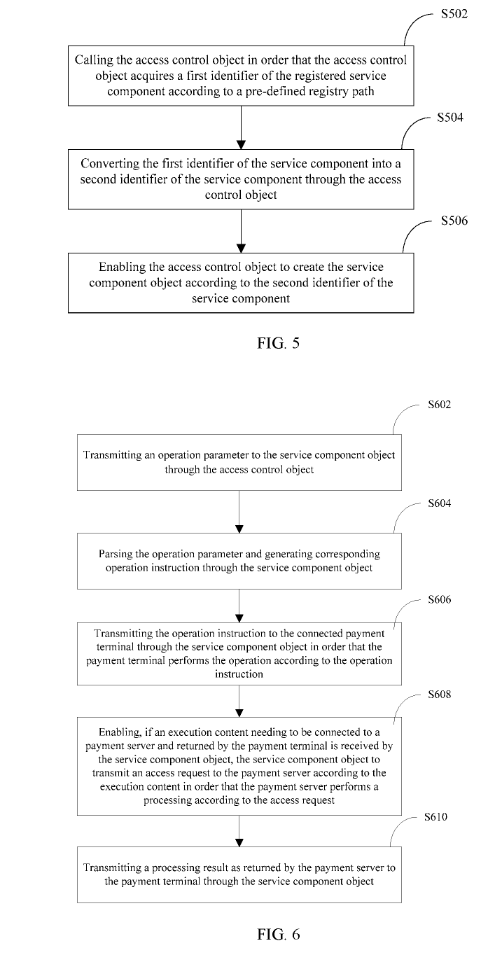

As shown in FIG. 5, in one embodiment, creating the service component object through the access control object includes the following steps:

Step 502, calling the access control object in order that the access control object acquires a first identifier of the registered service component according to a pre-defined registry path.

Particularly, the first identifier of the service component registered on the operating system of the intelligent device may be acquired by the access control object according to the pre-defined registry path, where the first identifier of the service component may be the ProgID of the service component, the ProgID is the program ID (identification) which may be composed of one or more among numbers, letters, symbols and the like, the name format of the ProgID is generally <program>.<component>.<version>, and the ProgID is an identifier which is designated by certain CLSID (Class ID) and is relatively simple, and is easy to be memorized.

Step 504, converting the first identifier of the service component into the second identifier of the service component through the access control object.

Particularly, the first identifier of the service component may be converted into the second identifier of the service component by the access control object in a preset manner, where, the second identifier of the service component may be a CLSID of the service component, each COM component is provided with a unique corresponding CLSID, the CLSID is generally composed of numerals of 16 bytes, CLSID may be configured to identify the COM component, thereby guaranteeing the uniqueness of the COM component in the global. The access control object may look over the registry according to the first identification of the service component and acquire the second identification of the corresponding service component, the first identifier of the service component may also be converted into the second identifier of the service component by the access control according to the function of such as CLSIDFromProgID and the ProgIDFromCLSID, and so on.

Step 506, enabling the access control object to create a service component object according to the second identifier of the service component.

Particularly, the CLSID of the service component may be configured to represent the actual path of the service component, the registered service component in the operating system may be acquired through the CLSID, and the service component object may be created by the access control object according to the CLSID of the service component, the service component object provides a series of interfaces for controlling the payment terminal 10, the access control object may access the payment terminal 10 by calling the interfaces provided by the service component object, and control the payment terminal 10 to perform the corresponding operation.

In this embodiment, the service component object may be created by the access control object according to the service component registered in the operating system, so that the service component object may be called to access and control the payment terminal 10, there is no need for the user to install a local application in the intelligent device in advance, the user may only need to open the browser to access the corresponding web page so as to use the connected payment terminal 10, the operation is simple, convenient and rapid.

In one embodiment, accessing the connected payment terminal 10 through the access control object and controlling the payment terminal 10 to perform the operation in step 350 may particularly include: calling the service component object through the access control object, in order that the service component object communicates with the connected payment terminal 10 and controls the payment terminal 10 to perform the operation.

Particularly, the created service component object may be called by the access control object, the service component object communicates with the connected payment terminal 10 and transmits the operation instruction to the payment terminal 10 through the USB (Universal Serial Bus) serial port, and the payment terminal 10 may perform the corresponding operation according to the operation instruction.

As shown in FIG. 6, in one embodiment, calling the service component object through the access control object in order that the service component object communicates with the connected payment terminal 10 and controls the payment terminal 10 to perform the operation may include the following steps:

Step 602, transmitting the operation parameters to the service component object through the access control object.

Particularly, the required operation on the page is selected by the user, the operation selected on the page is received by the intelligent terminal, and the corresponding interface in the control object may be called by the JS in the page according to the selected operation. The access control object may acquire the transmitted operation parameter when the interface is called by the JS and transmit the operation parameter to the access control object, where the operation parameter may include information such as an operation type, and the operation type may include payment, activating the payment terminal 10, card reading, password input, balance enquiry and the like. The service component object is called by the access control object and the acquired operation parameter is transmitted to the service component object by the access control object.

Step 604, parsing the operation parameter through the service component object generating corresponding operation instruction.

Particularly, the operation parameter is parsed by the service component object and the corresponding operation instruction is generated, for example, if the operation type is the card reading, the service component object may generate a corresponding card reading instruction.

Step 606, transmitting the operation instruction to the connected payment terminal 10 through the service component object in order that the payment terminal 10 performs an operation according to the operation instruction.

Particularly, the service component object may transmit the operation instruction to the payment terminal 10 connected with the intelligent terminal through the USB serial port, after the operation instruction is received by the payment terminal 10, the corresponding operation may be performed according to the operation instruction. After the operation is completed, the payment terminal 10 may return a corresponding operation result to the service component object, a success or failure event of the corresponding access control is activated by the service component object according to the operation result, and the operation result is displayed on the page. For example, the operation instruction is a card reading instruction, after the user swipes the card on the payment terminal 10, magnetic stripe information of a bank card may be read by the payment terminal 10 according to the card reading instruction, a reading success instruction may be returned to the service component object by the payment terminal 10 after the magnetic stripe information of the bank card is read successfully, and an access control success event is activated by the service component object according to the reading success instruction, and the card reading success is displayed on the page of the intelligent terminal 20.

Step 608, enabling, if an execution content needing to be connected to the payment server 30 and returned by the payment terminal 10 is received by the service component object, the service component object to transmit an access request to the payment server 30 according to the execution content in order that the payment server 30 performs a processing according to the access request.

Particularly, after the operation instruction is sent to the connected payment terminal 10 by the service component object, if the execution content needing to be connected to the payment server 30 and returned by the payment terminal 10 is received by the service component object, the access request may be transmitted to the payment server 30 by the service component object according to the execution content, and the processing is performed by the payment server 30 according to the execution content in the access request, where the payment server 30 refers to a bank server corresponding to payment operation.

For example, the operation selected by the user is payment, the service component object generates a payment instruction and transmits the payment instruction to the payment terminal 10, the payment terminal 10 needs to be connected to the payment server 30 when a payment operation is performed according to the payment instruction, the payment server 30 is used to deduct money from the user and transfer the money into a merchant, the payment terminal 10 may return the execution content to the service component object, and the execution content may include an instruction of requesting to connect to the payment server 30, a deducted card number, a card number of the merchant, the amount and the like; if the service component object detects that the payment server 30 needs to be connected according to the execution content, the access request is transmitted to the payment server 30 through the HTTP or the HTTPS protocol, and the payment is completed by the payment server 30 according to the execution content contained in the access request.

Step 610, transmitting a processing result as returned by the payment server 30 to the payment terminal 10 through the service component object.

Particularly, after the processing is performed by the payment server 30 according to the access request, the processing result may be returned to the service component object, the processing result is transmitted to the payment terminal 10 by the service component object, and a subsequent processing such as printing bills or displaying password errors and the like may be performed by the payment terminal 10 according to the processing result. After the processing result sent by the service component object is received by the payment terminal 10, a corresponding operation result may be returned to the service component object, a success event or a failure event of the corresponding access control is activated by the service component object according to the operation result, and the operation result is displayed on the page.

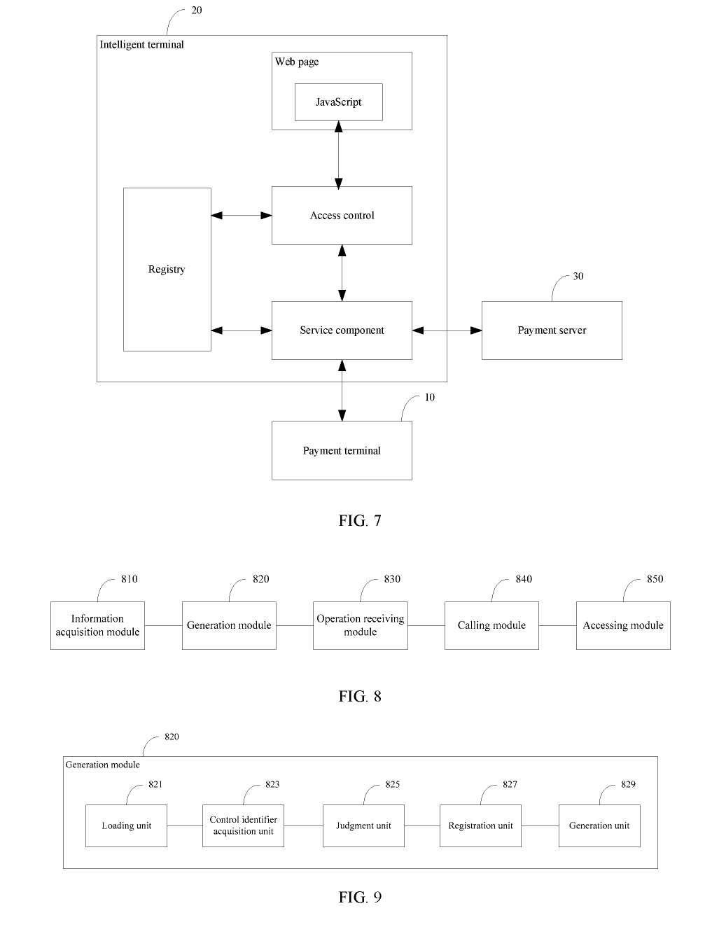

FIG. 7 depicts a system architecture diagram of a method for accessing a payment terminal 10 in one embodiment. As shown in FIG. 7, page access information of a page is acquired by an intelligent terminal 20 through a browser, and the corresponding web page is loaded according to the access information. An access control object is generated by JS (JavaScript) in the web page according to the access control registered in the registry and an interface corresponding to the access control object is called by the JS, such that the access control object creates a service component object according to the service component registered in the registry. The operation selected on the page is received by the intelligent terminal 20, and a corresponding interface in the access control object is called by the JS in the page according to the operation. The service component object is called by the access control object, the operation parameter which is transmitted when the interface is called by the JS is acquired and is transmitted to the service component object. The operation parameter is parsed by the service component object and the corresponding operation instruction is generated, and the operation instruction is transmitted to the payment terminal 10 connected with the intelligent terminal 20 by the service component object, and the corresponding operation is performed by the payment terminal 10 according to the operation instruction. If the execution content needing to be connected to the payment server 30 and returned by the payment terminal 10 is received by the service component object, an access request is transmitted to the payment server 30 by the service component object according to the execution content, a processing is performed by the payment server 30 according to the execution content in the access request and a processing result is returned to the service component object by the payment server 30. The processing result is transmitted to the payment terminal 10 by the service component object. After the operation is completed, the operation result may be transmitted to the service component object by the payment terminal 10, a success event or a failure event of the access control is activated by the service component object according to the operation result, and the operation result is displayed in the page.

In this embodiment, the access control object may call the service component object and communicate with the payment terminal 10 and the payment server 30 respectively through the service component object, there is no need for the user to install the local application in the intelligent device, the user may only need to open the browser to access the corresponding web page so as to use the connected payment terminal 10, and the operation is simple, convenient and rapid.

As shown in FIG. 8, in one embodiment, a device for accessing payment terminal 10 is provided, including in information acquisition module, a generation module, an operation receiving module 830, a calling module 840 and an access module 850.

The information acquisition module 810 is configured to acquire page access information through a browser.

The generation module 820 is configured to load a corresponding page according to the page access information and generate an access control object.

The operation receiving module 830 is configured to receive an operation selected on the page.

The calling module 840 is configured to call the access control object according to the operation.

The accessing module 850 is configured to access a connected payment terminal 10 through the access control object and control the payment terminal 10 to perform the operation.

In the aforesaid method for accessing payment terminal 10, the page access information is acquired through the browser, the corresponding page is loaded according to the page access information, and the access control object is generated, the operation selected on the page is generated, and the access control object is called according to the operation, the connected payment terminal 10 is accessed through the access control object, and the payment terminal 10 is controlled to perform the corresponding operation, the page may access and control the payment terminal 10 by calling the access control object, there is no need for the user to install a local application in the intelligent equipment in advance; the user may only need to open the browser to access the corresponding web page so as to use the connected payment terminal 10, and the operation is simple, rapid and convenient.

Moreover, with regard to different issuing parties of the payment terminal 10, there is no need for the issuing parties to develop an independent application for the user to use, the issuing parties only need to develop the corresponding web pages so that the access control may be called through the web page, huge development cost is saved.

As shown in FIG. 9, in one embodiment, the generation module 820 includes a loading unit 821, a control identifier acquisition unit 823, a judgment unit 825, a registration unit 827 and a generation unit 829.

The loading unit 821 is configured to load a corresponding page according to the page access information;

The control identifier acquisition unit 823 is configured to acquire an access control identifier from the page;

The judgment unit 825 is configured to judge whether there is a registered access control according to the access control identifier;

The judgment unit 825 is further configured to acquire the latest version number and the registered version number of the access control if there is the registered access control, and judge whether the access control object needs to be updated according to the latest version number and the registered version number;

The registration unit 827 is configured to download and register the latest version of the access control, if there is no registered access control or the access control needs to be updated; and

The generation unit 829 is configured to generate the access control object according to the registered access control.

In this embodiment, the corresponding page is loaded according to the page access information, and the access control object is generated, the page may access and control the payment terminal 10 by calling the access control object, there is no need for the user to install a local application in the intelligent equipment in advance; the user may only need to open the browser to access the corresponding web page so as to use the connected payment terminal 10, and the operation is simple, rapid and convenient.

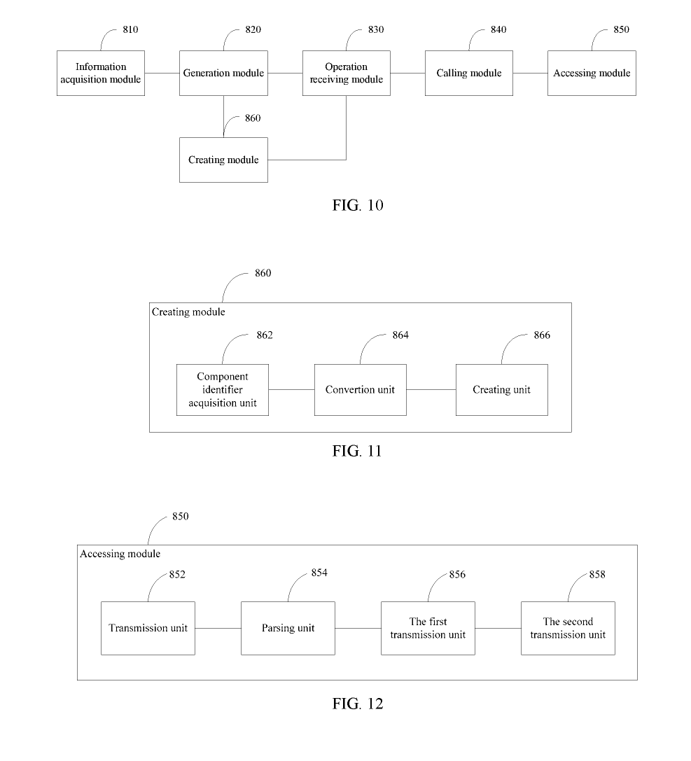

As shown in FIG. 10, in one embodiment, except that the aforesaid device for accessing payment terminal 10 includes the information acquisition module 810, the generation module 820, the operation receiving module 830, the calling module 840 and the accessing module 850, the device for accessing payment terminal 10 further includes a creating unit 860.

The creating unit 860 is configured to create a service component object through the access control object.

As shown in FIG. 11, the creating unit 860 includes a component identifier acquisition unit 862, a conversion unit 864 and a creating unit 866.

The component identifier acquisition unit 862 is configured to call the access control object in order that the access control object acquires a first identifier of the registered service component according to a pre-defined registry path;

The conversion unit 864 is configured to convert the first identifier of the service component into a second identifier of the service component through the access control object; and

The creating unit 866 is configured to enable the access control object to create the service component object according to the second identifier of the service component.

In this embodiment, the service component object may be created by the access control object according to the service component registered in the operating system, so that the service component object may be called to access and control the payment terminal 10, there is no need for the user to install a local application in the intelligent device in advance, the user may only need to open the browser to access the corresponding web page so as to use the connected payment terminal 10, the operation is simple, convenient and rapid.

In one embodiment, the accessing module 850 is further configured to call the service component object through the access control object in order that the service component object communicates with the connected payment terminal 10 and controls the payment terminal 10 to perform the operation.

As shown in FIG. 12, in one embodiment, the accessing module 850 includes a transmission unit 852, a parsing unit 854, a first transmission unit 856 and a second transmission unit 858.

The transmission unit 852 is configured to transmit an operation parameter to the service component object through the access control object;

The parsing unit 854 is configured to parse the operation parameter through the service component object and generate corresponding operation instruction;

The first transmission unit 856 is configured to transmit the operation instruction to the connected payment terminal 10 through the service component object, in order that the payment terminal 10 performs the operation according to the operation instruction;

The second transmission unit 858 is configured to enable, if an execution content required to be connected to a payment server 30 and returned by the payment terminal 10 is received by the service component object, the service component object to transmit an access request to the payment server 30 according to the execution content in order that the payment server 30 performs a processing according to the access request; and

The second transmission unit 856 is further configured to transmit a processing result as returned by the payment server 30 to the payment terminal 10 through the service component object.

In this embodiment, the access control object may call the service component object and communicate with the payment terminal 10 and the payment server 30 respectively through the service component object, there is no need for the user to install the local application in the intelligent device, the user may only need to open the browser to access the corresponding web page so as to use the connected payment terminal 10, and the operation is simple, convenient and rapid.

The various modules in the aforesaid device for accessing payment terminal 10 may be implemented entirely or partially through software, hardware or the combination of software and hardware. For example, in hardware implementation, the generation module 820 may use the processor of the terminal to load the corresponding page according to the page access information and generate the access control object, where the processor may be a CPU (Central Processing Unit), a microprocessor and the like; the operation receiving module 830 may receive the operation selected on the page through the input device of the terminal, and the like, where the input device may be a touch layer covered on the display screen, and may also be a key, a trackball or a touch panel which are arranged on the outer shell of the terminal. The aforesaid modules may be embedded in the processor of the terminal in a hardware form or be independent of the processor of the terminal, and may also be stored in the memory of the terminal in a software form, which facilitates the processor to call and perform the operations corresponding to the above various modules.

In one embodiment, a terminal including a memory and a processor is provided, the memory stores a computer executable instruction, when the computer executable instruction is executed by the processor, the processor is caused to perform the method for accessing the payment terminal 10 described above.

In one embodiment, one or a plurality of non-volatile readable storage medium storing the computer executable instruction is provided, when the computer executable instruction is executed by one or a plurality of processors, the method for accessing the payment terminal 10 described above may be implemented.

The person of ordinary skilled in the art may be aware of that, a whole or a part of flow process of implementing the method in the aforesaid embodiments of the present disclosure may be accomplished by using computer program to instruct relevant hardware. The computer program may be stored in a non-volatile computer readable storage medium, when the computer program is executed, the steps in the various method embodiments described above may be included. Where, the storage medium may be a magnet disk, a optical disk, ROM (Read-Only Memory), and so on.

The various technical features in the aforesaid embodiments may be combined arbitrarily, for the convenience of describing, not all possible combinations of the various technical features in the embodiments described above are described; however, the combinations of these technical features should all be considered as falling within the protection scope of the description as long as they are not contradicted with each other.

Some implementation modes of the present disclosure are described in the embodiments described above, and the descriptions of these implementation modes are specific and in detail, but should not be interpreted as limitations to the patent protection scope of the present disclosure. It should be noted that, as for the person of ordinary skill in the art, the person of ordinary skill in the art may also make some modifications and improvements without breaking away from the inventive concept of the present disclosure, and these modifications and improvements are all included in the protection scope of the present disclosure. Thus, the protection scope of the present disclosure should be determined by the attached claims.

1. A method of accessing a payment terminal, comprising:
acquiring page access information through a browser;
loading a corresponding page according to the page access information and generating an access control object;
receiving an operation selected on the page;
calling the access control object according to the operation; and
accessing a connected payment terminal through the access control object and controlling the payment terminal to perform the operation.

2. The method according to claim 1, wherein the step of loading a corresponding page according to the page access information and generating an access control object comprises:
loading the corresponding page according to the page access information;
acquiring an access control identifier from the page;
judging whether there is a registered access control according to the access control identifier;
acquiring the latest version number and the registered version number of the access control and judging whether the access control needs to be updated according to the latest version number and the registered version number, if there is the registered access control;
downloading and registering the latest version of the access control, if there is no registered access control or the access control needs to be updated; and
generating the access control object according to the registered access control.

3. The method according to claim 1, wherein the step of accessing a connected payment terminal through the access control object and controlling the payment terminal to perform the operation comprises the step of:
calling a service component object through the access control object, in order that the service component object communicates with the connected payment terminal and controls the payment terminal to perform the operation.

4. The method according to claim 3, wherein after the step of loading a corresponding page according to the page access information and generating the access control object, the method further comprises the steps of:
creating the service component object through the access control object; and
wherein the step of creating the service component object through the access control object comprises the steps of:
calling the access control object, in order that the access control object acquires a first identifier of the registered service component according to a pre-defined registry path;
converting the first identifier of the service component into a second identifier of the service component through the access control object; and
enabling the access control object to create the service component object according to the second identifier of the service component.

5. The method according to claim 3, wherein the step of calling a service component object through the access control object in order that the service component object communicates with the connected payment terminal and controls the payment terminal to perform the operation comprises the steps of:
transmitting an operation parameter to the service component object through the access control object;
parsing the operation parameter through the service component object and generating corresponding operation instruction;
transmitting the operation instruction to the connected payment terminal through the service component object, in order that the payment terminal performs the operation according to the operation instruction;
enabling, if an execution content required to be connected to a payment server and returned by the payment terminal is received by the service component object, the service component object to transmit an access request to the payment server according to the execution content in order that the payment server performs a processing according to the access request; and
transmitting a processing result as returned by the payment server to the payment terminal through the service component object.

6. A terminal, comprising a memory and a processor, the memory being configured to store computer-executable instruction, wherein when the computer-executable instruction is executed by the processor, the processor is caused to perform following steps of:
acquiring page access information through a browser;
loading a corresponding page according to the page access information and generating an access control object;
receiving an operation selected on the page;
calling the access control object according to the operation; and
accessing a connected payment terminal through the access control object and controlling the payment terminal to perform the operation.

7. The terminal according to claim 6, wherein the step of loading a corresponding page according to the page access information and generating an access control object comprises:
loading the corresponding page according to the page access information;
acquiring an access control identifier from the page;
judging whether there is a registered access control according to the access control identifier;
acquiring the latest version number and the registered version number of the access control and judging whether the access control needs to be updated according to the latest version number and the registered version number, if there is the registered access control;
downloading and registering the latest version of the access control, if there is no registered access control or the access control needs to be updated; and
generating the access control object according to the registered access control.

8. The terminal according to claim 6, wherein the step of accessing a connected payment terminal through the access control object and controlling the payment terminal to perform the operation comprises the step of:
calling a service component object through the access control object, in order that the service component object communicates with the connected payment terminal and controls the payment terminal to perform the operation.

9. The method according to claim 8, wherein after the processor is caused to perform the step of loading the corresponding page according to the page access information and generating the access control object when the computer-executable instruction is executed by the processor, the processor is further caused to perform the step of:
creating the service component object through the access control object; and
wherein the step of creating the service component object through the access control object comprises the steps of:
calling the access control object, in order that the access control object acquires a first identifier of the registered service component according to a pre-defined registry path;
converting the first identifier of the service component into a second identifier of the service component through the access control object; and
enabling the access control object to create the service component object according to the second identifier of the service component.

10. The terminal according to claim 8, wherein the step of calling a service component object through the access control object, in order that the service component object communicates with the connected payment terminal and controls the payment terminal to perform the operation comprises the steps of:
transmitting an operation parameter to the service component object through the access control object;
parsing the operation parameter through the service component object and generating corresponding operation instruction;
transmitting the operation instruction to the connected payment terminal through the service component object, in order that the payment terminal performs the operation according to the operation instruction;
enabling, if an execution content required to be connected to a payment server and returned by the payment terminal is received by the service component object, the service component object to transmit an access request to the payment server according to the execution content in order that the payment server performs a processing according to the access request; and
transmitting a processing result as returned by the payment server to the payment terminal through the service component object.

11. A non-volatile readable storage medium storing computer-executable instruction, wherein when the computer-executable instruction is executed by one or a plurality of processors, the one or plurality of processors are caused to perform the following steps of:
acquiring page access information through a browser;
loading a corresponding page according to the page access information and generating an access control object;
receiving an operation selected on the page;
calling the access control object according to the operation; and
accessing a connected payment terminal through the access control object and controlling the payment terminal to perform the operation.

12. The non-volatile readable storage medium according to claim 11, wherein the step of loading a corresponding page according to the page access information and generating an access control object comprises:
loading the corresponding page according to the page access information;
acquiring an access control identifier from the page;
judging whether there is a registered access control according to the access control identifier;
acquiring the latest version number and the registered version number of the access control and judging whether the access control needs to be updated according to the latest version number and the registered version number, if there is the registered access control;
downloading and registering the latest version of the access control, if there is no registered access control or the access control needs to be updated; and
generating the access control object according to the registered access control.

13. The non-volatile readable storage medium according to claim 11, wherein the step of accessing a connected payment terminal through the access control object and controlling the payment terminal to perform the operation comprises the step of:
calling a service component object through the access control object, in order that the service component object communicates with the connected payment terminal and controls the payment terminal to perform the operation.

14. The non-volatile readable storage medium according to claim 13, wherein after the processor is further caused to perform the step of loading a corresponding page according to the page access information and generating the access control object when the computer-executable instruction is executed by the processor, the processor is further caused to perform the step of:
creating the service component object through the access control object; and
wherein the step of creating the service component object through the access control object comprises the steps of:
calling the access control object, in order that the access control object acquires a first identifier of the registered service component according to a pre-defined registry path;
converting the first identifier of the service component into a second identifier of the service component through the access control object; and
enabling the access control object to create the service component object according to the second identifier of the service component.

15. The non-volatile readable storage medium according to claim 13, the step of calling a service component object through the access control object, in order that the service component object communicates with the connected payment terminal and controls the payment terminal to perform the operation comprises the steps of:
transmitting an operation parameter to the service component object through the access control object;
parsing the operation parameter through the service component object and generating corresponding operation instruction;
transmitting the operation instruction to the connected payment terminal through the service component object, in order that the payment terminal performs the operation according to the operation instruction;
enabling, if an execution content required to be connected to a payment server and returned by the payment terminal is received by the service component object, the service component object to transmit an access request to the payment server according to the execution content in order that the payment server performs a processing according to the access request; and
transmitting a processing result as returned by the payment server to the payment terminal through the service component object.
